(19) United States
(12) Patent Application Publication
(10) Pub. No.: US 2015/0241804 A1
(43) Pub. Date: Aug. 27, 2015

(54) TONER AND DEVELOPER

(71) Applicants: Satoshi TAKAHASHI, Kanagawa (JP); Yoshihiro MORIYA, Shizuoka (JP); Ryota INOUE, Shizuoka (JP); Masahiko ISHIKAWA, Shizuoka (JP); Tatsuki YAMAGUCHI, Shizuoka (JP)

(72) Inventors: Satoshi TAKAHASHI, Kanagawa (JP); Yoshihiro MORIYA, Shizuoka (JP); Ryota INOUE, Shizuoka (JP); Masahiko ISHIKAWA, Shizuoka (JP); Tatsuki YAMAGUCHI, Shizuoka (JP)

(21) Appl. No.: 14/626,113

(22) Filed: Feb. 19, 2015

(30) Foreign Application Priority Data
Feb. 27, 2014 (JP) 2014-036295
Dec. 25, 2014 (JP) 2014-261707

(51) Int. Cl. G03G 9/08; G03G 9/087

(52) U.S. Cl. CPC G03G 9/0819; G03G 9/0827; G03G 9/08733; G03G 9/08

(57) ABSTRACT

A toner is provided. The toner includes particles each including a binder resin and a release agent. When the toner is analyzed by a flow particle image analyzer while limiting:
1) a particle diameter analysis range to 1.985 (μm)≦equivalent circle diameter (number based)<200.0 (μm);
2) a particle shape analysis range to 0.200≦circularity≦1.000; and
3) the number of limited particles satisfying the conditions 1) and 2) to from 4,800 to 5,200, an average circularity Rave. satisfies an inequation 0.960≦Rave.≦0.980, a mode particle diameter θmax satisfies an inequation 4.0 (μm)≦θmax≦6.0 (μm), and the number of particles having a particle diameter equal to or less than 0.75 times the mode particle diameter θmax and a circularity equal to or more than 0.980 is 1.0% or less of the number of the limited particles.

### CROSS-REFERENCE TO RELATED APPLICATIONS

This patent application is based on and claims priority pursuant to 35 U.S.C. §119(a) to Japanese Patent Application Nos. 2014-036295 and 2014-261707, filed on Feb. 27, 2014 and Dec. 25, 2014, respectively, in the Japan Patent Office, the entire disclosure of each of which is hereby incorporated by reference herein.

### BACKGROUND

1. Technical Field

The present disclosure relates to a toner for developing electrostatic charge image in the fields of electrophotography, electrostatic recording, electrostatic printing, etc., and further relates to a developer including the toner.

2. Description of the Related Art

In electrophotography, electrostatic recording, electrostatic printing, etc., a toner is once adhered to a latent image bearer, such as an electrostatic latent image bearer, on which an electrostatic latent image has been formed in a process called developing process. The toner is then transferred from the electrostatic latent image bearer onto a transfer medium such as paper in a process called transfer process. The toner is then fixed on the transfer medium in a process called fixing process.

A certain amount of toner particles remains on the latent image bearer without being transferred. Such residual toner particles should be removed from the latent image bearer so as not to prevent formation of a next electrostatic latent image.

As a means for removing the residual toner particles, a blade cleaner is widely used, which has a simple configuration and high cleaning ability. It is known that as the particle diameter of toner gets smaller or the shape of toner gets close to a sphere, it becomes more difficult to remove such toner and clean the latent image bearer.

Recently, a polymerization toner produced by a suspension polymerization method and another toner produced by a polymer dissolution suspension method that causes volume contraction have been proposed.

Each of these toners has a small particle diameter but the particle size distribution is relatively wide. To improve transfer efficiency of these toners, the particle diameter should be more narrowed.

Polymerization toners generally have a spherical shape. There has been an attempt to produce a non-spherical or irregular-shape toner by a suspension polymerization method. In this attempt, an irregular-shape-forming agent, such as an inorganic filler or layered inorganic mineral, is contained in a toner and controlled to exist at the surface of the toner.

Because of having a certain particle size itself, it is likely that the organic filler or layered inorganic mineral cannot be incorporated in small particles and therefore the small particles become spherical. As a result, the resulting toner particles are varied in irregularity and the shape distribution becomes wide. The inclusion of an inorganic filler or layered inorganic mineral makes the toner have an irregular shape and improves cleanability of the toner. However, at the same time, the release agent is prevented from exuding and the binder resin is prevented from melting, thereby degrading low-temperature fixability, hot offset resistance, and extendability of the toner.

### SUMMARY

In accordance with some embodiments of the present invention, a toner is provided. The toner includes particles each including a binder resin and a release agent. When the toner is analyzed by a flow particle image analyzer while limiting:

1) a particle diameter analysis range to 1.985 (μm)≦equivalent circle diameter (number based)<200.0 (μm);
2) a particle shape analysis range to 0.200≦circularity≦1.000; and
3) the number of limited particles satisfying the conditions 1) and 2) to from 4,800 to 5,200, an average circularity Rave. satisfies an inequation 0.960≦Rave.≦0.980, a mode particle diameter θmax satisfies an inequation 4.0 (μm)≦θmax≦6.0 (μm), and the number of particles having a particle diameter equal to or less than 0.75 times the mode particle diameter θmax and a circularity equal to or more than 0.980 is 1.0% or less of the number of the limited particles.

In accordance with some embodiments of the present invention, a developer is provided. The developer includes the above toner and a carrier.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1A and 1B are explanatory charts with respect to the standard deviation of the count number in accordance with some embodiments of the present invention;

FIG. 2 is a schematic cross-sectional view of a liquid column resonance liquid droplet discharge device in accordance with some embodiments of the present invention;

FIG. 3 is a schematic cross-sectional view of a toner manufacturing apparatus in accordance with some embodiments of the present invention;

FIG. 4 is a schematic cross-sectional view of another liquid column resonance liquid droplet discharge device in accordance with some embodiments of the present invention;

FIG. 5 is a schematic cross-sectional view of another toner manufacturing apparatus in accordance with some embodiments of the present invention;

FIG. 6 is a schematic cross-sectional view of discharge holes in a liquid column resonance liquid chamber in accordance with some embodiments of the present invention; and

FIGS. 7A to 7H are scanning electron microscopic images of the toners of Example 1, Example 2, Example 3, Example 4, Example 5, Comparative Example 1, Comparative Example 2, and Comparative Example 1, respectively.

### DETAILED DESCRIPTION

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

For the sake of simplicity, the same reference number will be given to identical constituent elements such as parts and materials having the same functions and redundant descriptions thereof omitted unless otherwise stated.

One object of the present invention is to provide a toner having a particle size not too small and a shape not too close to a sphere, narrow and very uniform particle size distribution and circularity distribution, and excellent cleanability and transferability.

In accordance with some embodiments of the present invention, a toner having a particle size not too small and a shape not too close to a sphere, narrow and very uniform particle size distribution and circularity distribution, and excellent cleanability and transferability is provided.

### Toner

The toner according to some embodiments of the present invention includes at least a binder resin and a release agent, and optionally other components such as a colorant and a charge controlling agent.

### Binder Resin

The binder resin is not limited to any particular material. For example, in a case in which the toner is produced by a later-described method in which toner compositions are dissolved or dispersed in an organic solvent, an organic-solvent-soluble resin can be used as the binder resin. Specific examples of the binder resin include, but are not limited to, a vinyl polymer or copolymer obtainable from a styrene monomer, an acrylic monomer, and/or a methacrylic monomer, polyester resin, polyol resin, phenol resin, silicone resin, polyurethane resin, polyamide resin, furan resin, epoxy resin, xylene resin, terpene resin, coumarone indene resin, polycarbonate resin, and petroleum resin.

Two or more of these resins can be used in combination.

Preferably, a molecular weight distribution of the binder resin which is measured by gel permeation chromatography (GPC) has at least one peak within a molecular weight range of from 3,000 to 50,000, more preferably from 5,000 to 20,000, from the viewpoint of fixability and offset resistance of the toner.

Preferably, the binder resin contains THF (tetrahydrofuran) solubles having a molecular weight of 100,000 or less in an amount of from 60% to 100%.

Preferably, the binder resin has an acid value of from 0.1 to 50 mgKOH/g. The acid value of the binder resin can be measured based on a method according to JIS K-0070.

### Release Agent

The release agent is not limited to any particular material. For example, in a case in which the toner is produced by a later-described method in which toner compositions are dissolved or dispersed in an organic solvent, an organic-solvent-soluble release agent can be used as the binder resin. Specific examples of the release agent include, but are not limited to, aliphatic hydrocarbon waxes (e.g., low-molecular-weight polyethylene, low-molecular-weight polypropylene, polyolefin wax, microcrystalline wax, paraffin wax, SASOL wax), oxides of aliphatic hydrocarbon waxes (e.g., oxidized polyethylene wax) and block copolymers thereof, plant waxes (e.g., candelilla wax, carnauba wax, sumac wax, jojoba wax), animal waxes (e.g., bees wax, lanolin, spermaceti), mineral waxes (e.g., ozokerite, ceresin, petrolatum), waxes mainly composed of fatty acid esters (e.g., montanate wax, castor wax), and partially or completely deoxidized fatty acid esters (e.g., deoxidized carnauba wax).

The toner may include one type of release agent. Preferably, the toner includes two or more types of release agents having different endothermic peaks (melting points). When one type of release agent is used, there is a possibility that the release agent is contained inside the toner and the fixable temperature range becomes narrow. When two or more types of release agents having different melting points are used in combination, at least one of the release agents can exist both inside the toner and at the surface of the toner. Accordingly, the fixable temperature range is secured and the toner is formed into an irregular shape. Generally, release agents having different melting points are also different in solubility in organic solvents. A release agent having a higher melting point has a higher molecular weight and therefore has a lower solubility in organic solvents. A release agent having a lower melting point has a lower molecular weight and therefore has a higher solubility in organic solvents.

The release agent having a lower solubility is likely to exist at the surface of the toner because it deposits at high speed in a solvent-drying process in the later-described toner production method. The release agent having a higher solubility is likely to exist inside the toner because it deposits at low speed and crystallizes inside the toner in a solvent-drying process in the later-described toner production method. When two or more types of release agents having different melting points are used in combination, the release agent can exist both inside the toner and at the surface of the toner due to their difference in solubility. Accordingly, the fixable temperature range is secured and the toner is formed into an irregular shape.

The release agent is not limited in melting point. The release agent preferably has a melting point of from 70° C. to 140° C., more preferably from 70° C. to 120° C., for achieving a good balance between fixability and offset resistance. When the melting point is less than 70° C., blocking resistance may deteriorate. When the melting point exceeds 140° C., off resistance may not express very well.

When two or more types of release agents having different melting points are used in combination, the difference in melting point between the release agents is preferably 5° C. or more. When the difference is less than 5° C., it means that the difference in solubility is so small that the fixable temperature range may not be secured and the toner may not be formed into an irregular shape.

The melting point of the release agent is defined as a temperature at which the maximum endothermic peak is observed in an endothermic curve of the release agent measured by DSC (differential scanning calorimetry).

To make the toner have desired particle diameter and shape, the type and content of the release agent should be considered carefully.

Preferably, a release agent component which is extracted from 1.0 g of the toner with n-hexane has two or more endothermic peaks in its endothermic curve obtained by DSC (differential scanning calorimetry). More preferably, the two or more endothermic peaks are observed in a temperature range not less than 60° C. and less than 80° C.

Preferably, the weight W of the release agent component extracted from 1.0 g of the toner with n-hexane is from 30 to 100 mg, i.e., 30 (mg)≦W≦100 (mg) is satisfied.

The weight W of the release agent component can be measured according to a later-described method in Example.

Preferably, the weight W of the release agent component is from 4 to 30 parts by weight, more preferably from 4 to 17 parts by weight, based on 100 parts by weight of the binder resin.

Preferably, the endothermic peak (melting point) of the release agent or toner is measured with a high-precision inner-heat power-compensation differential scanning calorimeter based on a method according to ASTM D3418-82. The endothermic curve is obtained by preliminarily heating and cooling a sample to remove its thermal history and then heating the sample at a heating rate of 10° C./min.

### Other Components

The toner according to some embodiments of the present invention may optionally include other components such as a colorant and a charge controlling agent.

### Colorant

The colorant is not limited to any particular material and selected in accordance with the intended purpose.

The content of the colorant is preferably from 1% to 15% by weight, more preferably from 3% to 10% by weight, based on total weight of the toner.

The colorant can be combined with a resin to be used as a master batch.

The master batch can be obtained by mixing and kneading a resin and a colorant while applying a high shearing force. The resin for use in the master batch is not limited to any particular material and selected in accordance with the intended purpose.

Two or more resins can be used in combination.

The content of the master batch is preferably from 0.1 to 20 parts by weight based on 100 parts by weight of the binder resin.

When preparing the master batch, a dispersant may be used to improve dispersibility of colorant.

Dispersants having high affinity for the binder resin are preferable from the viewpoint of colorant dispersibility. Specific examples of such dispersants include, but are not limited to, commercially available dispersants such as AJISPER PB821 and PB822 (from Ajinomoto Fine-Techno Co., Inc.), DISPERBYK-2001 (from BYK-Chemie GmbH), and EFKA-4010 (from EFKA).

The addition amount of the colorant dispersant is preferably from 1 to 200 parts by weight, more preferably from 5 to 80 parts by weight, based on 100 parts by weight of the colorant. When the addition amount is less than 1 part by weight, colorant dispersibility may deteriorate. When the addition amount exceeds 200 parts by weight, chargeability may deteriorate.

### Charge Controlling Agent

Specific examples of the charge controlling agent include, but are not limited to, nigrosine dyes, triphenylmethane dyes, chromium-containing metal complex dyes, chelate pigments of molybdic acid, Rhodamine dyes, alkoxyamines, quaternary ammonium salts (including fluorine-modified quaternary ammonium salts), alkylamides, phosphor and phosphor-containing compounds, tungsten and tungsten-containing compounds, fluorine activators, metal salts of salicylic acid, and metal salts of salicylic acid derivatives. Two or more of these resins can be used in combination.

### Toner Properties

When the toner according to some embodiments of the present invention is analyzed by a flow particle image analyzer while limiting:

1) a particle diameter analysis range to 1.985 (μm)≦equivalent circle diameter (number based)<200.0 (μm);
2) a particle shape analysis range to 0.200≦circularity≦1.000; and
3) the number of limited particles satisfying the conditions 1) and 2) to from 4,800 to 5,200, an average circularity Rave. satisfies an inequation 0.960≦Rave.≦0.980, a mode particle diameter θmax satisfies an inequation 4.0 (μm)≦θmax≦6.0 (μm), and the number of particles having a particle diameter equal to or less than 0.75 times the mode particle diameter θmax and a circularity equal to or more than 0.980 is 1.0% or less of the number of the limited particles.

Such a toner has satisfactory cleanability and transferability.

When circularity is divided into circularity ranges at an interval of 0.01, and the number of particles falling in each circularity range is counted, the standard deviation of the count number is preferably 220 or more.

How to measure the standard deviation of the count number is described below.

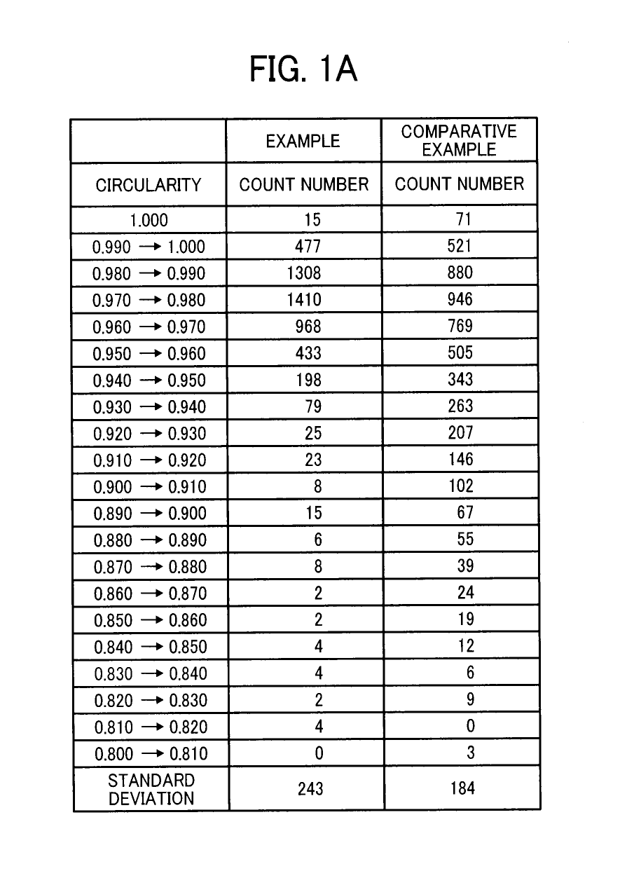

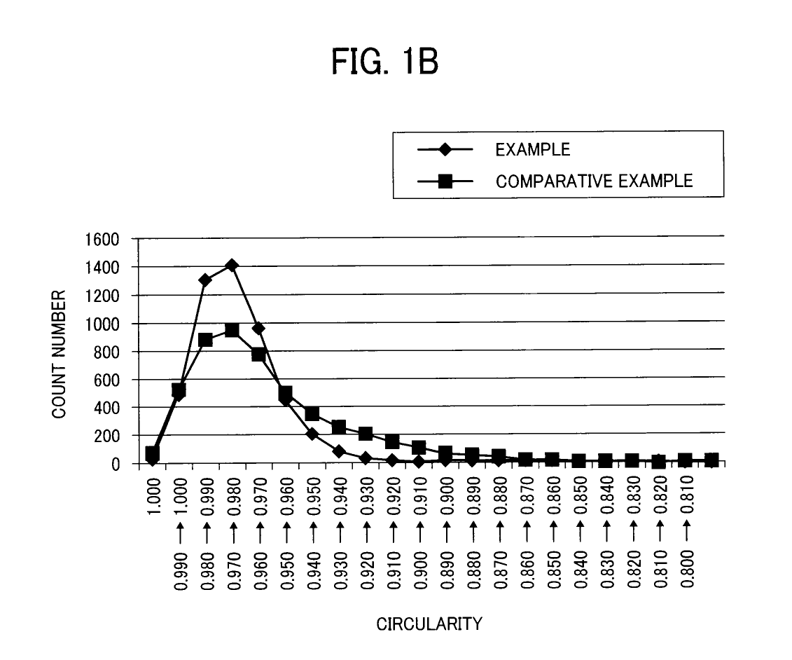

As a result of the measurement by the flow particle image analyzer, the number of particles falling in each circularity range is measured, as illustrated in FIGS. 1A and 1B. In FIGS. 1A and 1B, a circularity range of from 0.800 to 0.810 is illustrated as the lower limit range, however, the actual measurement involves a circularity range of from 0.200 to 0.210 as the lower limit range.

As illustrated in FIGS. 1A and 1B, circularity is divided into circularity ranges at an interval of 0.01, each ranging: from 0.990 to 1.000; from 0.980 to 0.990; . . . ; and from 0.200 to 0.210, and the number of particles falling in each circularity range is counted.

The standard deviation measures the amount of variation. As the amount of variation gets smaller, the standard deviation gets closer to zero. As the amount of variation gets larger, the standard deviation gets larger. As is clear from the measurement results for EXAMPLE illustrated in FIGS. 1A and 1B, as the number of particles falling in a specific circularity range gets larger, the standard deviation gets larger. In other words, as the circularity distribution gets narrower, the standard deviation gets larger. By contrast, as the circularity distribution gets wider, the standard deviation gets smaller, as is clear from the measurement results for COMPARATIVE EXAMPLE.

Accordingly, when circularity is divided into circularity ranges at an interval of 0.01, and the number of particles falling in each circularity range is counted, the standard deviation of the count number is preferably 220 or more. Such a toner having a narrow circularity distribution has satisfactory cleanability and transferability.

The particle size distribution Dv/Dn (i.e., the ratio of the volume average particle diameter Dv (μm) to the number average particle diameter Dn (μm)) of the toner preferably satisfies the following inequation: 1.00≦Dv/Dn<1.15.

### Measurement of Particle Diameter and Circularity

The volume average particle diameter (Dv), number average particle diameter (Dn), and circularity of the toner are measured by a flow particle image analyzer.

In the present disclosure, the measurement is performed by a flow particle image analyzer FPIA-3000 from Sysmex Corporation under the above-described analysis conditions.

The FPIA-3000 measures and analyzes particle images by means of imaging flow cytometry. A dispersion liquid of a sample is passed through a flow path (extending in a direction of flow) in a flat transparent flow cell (having a thickness of about 200 μm). A stroboscopic illumination and a CCD camera are each located on opposite sides of the flow cell so that an optical path is formed crossing the thickness direction of the flow cell. While the dispersion liquid is flowing, the stroboscopic illumination emits light at an interval of 1/60 seconds to obtain a two-dimensional image of the particles flowing in the flow cell. The two-dimensional image is at least partially parallel to the flow cell. Equivalent circle diameter (Dv, Dn) of each particle is determined from the diameter of a circle having the same area as the two-dimensional image of the particle.

Circularity of each particle is determined from the ratio of the perimeter (L) of a circle having the same area as the two-dimensional image of the particle to the perimeter (l) of the two-dimensional image of the particle.

As the circularity (i.e., the ratio L/l) approaches one, the particle shape gets close to a true sphere.

Under the above-described analysis conditions, average circularity Rave., mode particle diameter (number-based) θmax, the ratio of the number of particles having a particle diameter equal to or less than 0.75 times the mode particle diameter θmax and a circularity equal to or more than 0.980 to the number of limited particles, and the standard deviation of the count number are determined.

The limited particles refer to particles satisfying the above-described conditions 1) and 2). The concentration of the dispersion liquid is adjusted so that the number of the limited particles falls within a range of from 4,800 to 5,200.

The toner according to some embodiments of the present invention is preferably produced by a method described below. This method can produce a toner with desired particle diameter and shape without using any irregular-shape-forming agent such as inorganic filler or layered inorganic mineral.

### Method and Apparatus for Manufacturing Toner

A method of manufacturing the toner according to some embodiments of the present invention includes at least a liquid droplet formation process and a liquid droplet solidification process, and optionally other processes, if necessary.

An apparatus for manufacturing the toner according to some embodiments of the present invention includes at least a liquid droplet formation device and a liquid droplet solidification device, and optionally other devices, if necessary.

The method of manufacturing the toner is preferably performed by the apparatus for manufacturing the toner. The liquid droplet formation process is preferably performed by the liquid droplet formation device. The liquid droplet solidification process is preferably performed by the liquid droplet solidification device. The other processes are preferably performed by the other devices.

### Liquid Droplet Formation Process and Liquid Droplet Formation Device

The liquid droplet formation process is a process of discharging a toner composition liquid in which the binder resin and the release agent are dissolved or dispersed to form it into liquid droplets.

The liquid droplet formation device is a device for discharging a toner composition liquid in which the binder resin and the release agent are dissolved or dispersed to form it into liquid droplets.

The toner composition liquid is prepared by dissolving or dispersing toner compositions in an organic solvent. The toner compositions include at least the binder resin and the release agent, and optionally other components, if necessary.

The organic solvent is not limited to any particular material so long as it is volatile and capable of dissolving or dispersing the toner compositions without causing a phase separation of the binder resin from the release agent.

The process of discharging the toner composition liquid and form it into liquid droplets is performed by a liquid droplet discharge device.

### Liquid Droplet Discharge Device

The liquid droplet discharge device is not limited in configuration so long as the discharged liquid droplets have a narrow particle diameter distribution. The liquid droplet discharge device is of several types: a single-fluid nozzle, a two-fluid nozzle, a film-vibration-type discharge device, a Rayleigh-fission-type discharge device, a liquid-vibration-type discharge device, and a liquid-column-resonance-type discharge device.

For example, a film-vibration-type discharge device is described in JP-2008-292976-A, a Rayleigh-fission-type discharge device is described in JP-4647506-B2 (corresponding to JP-2007-199463-A), and a liquid-vibration-type discharge device is described in JP-2010-102195-A, the disclosure of each of which incorporated herein by reference.

To narrow the particle diameter distribution of the liquid droplets and secure the productivity of the toner, the liquid-column-resonance-type discharge device is preferably used. In the liquid-column-resonance-type discharge device, a vibration is applied from a vibrator to the toner composition liquid contained in a liquid column resonance liquid chamber having multiple discharge holes to form a liquid column resonant standing wave therein, and the toner composition liquid is periodically discharged from the multiple discharge holes formed within an area corresponding to antinodes of the liquid column resonant standing wave.

### Liquid Column Resonance Liquid Droplet Discharge Device

One example of the liquid-column-resonance-type liquid droplet discharge device is described in detail below.

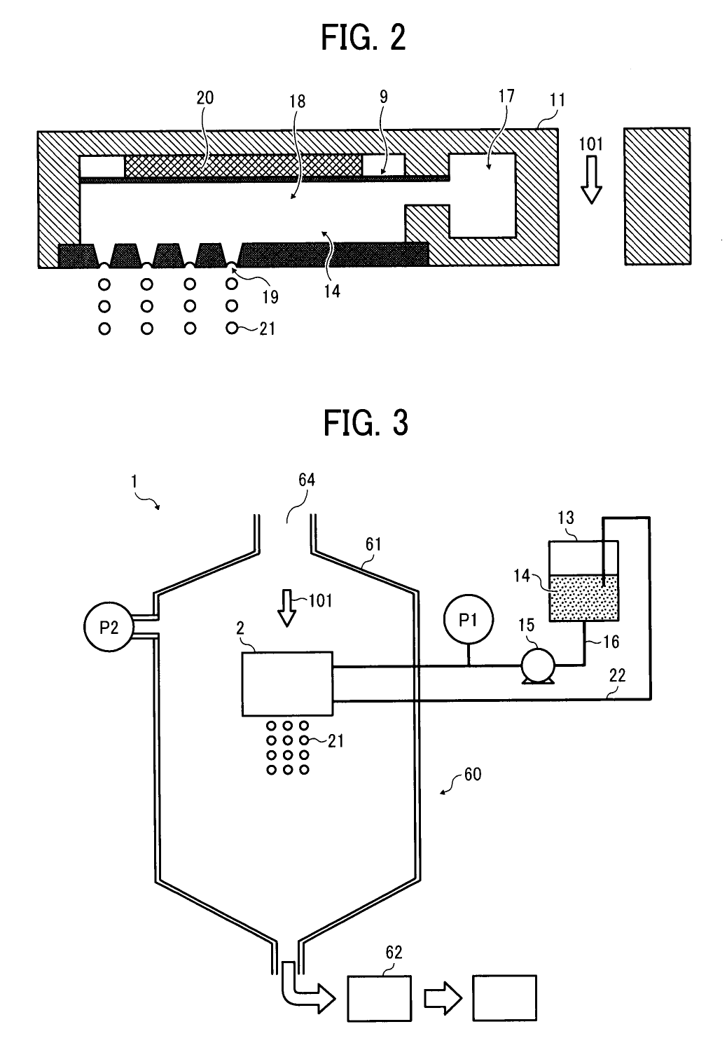

FIG. 2 is a cross-sectional view of a liquid column resonance liquid droplet forming device in accordance with some embodiments of the present invention. The liquid column resonance liquid droplet discharge device 11 has a liquid common supply path 17 and a liquid column resonance liquid chamber 18. The liquid column resonance liquid chamber 18 is communicated with the liquid common supply path 17 disposed on its one end wall surface in a longitudinal direction. The liquid column resonance liquid chamber 18 has discharge holes 19 to discharge liquid droplets 21, on its one wall surface which is connected with its both longitudinal end wall surfaces. The liquid column resonance liquid chamber 18 also has a vibration generator 20 to generate high-frequency vibration for forming a liquid column resonant standing wave and an elastic plate 9, on the wall surface facing the discharge holes 19. The vibration generator 20 is connected to a high-frequency power source.

### Liquid Droplet Solidification Process and Liquid Droplet Solidification Device

The liquid droplet solidification process is a process of solidifying the liquid droplets to form a toner. This process includes a solidification treatment in which the liquid droplets of the toner composition liquid discharged from the liquid droplet discharge device into a gas phase are solidified and a collection treatment in which the solidified particles and collected. The liquid droplet solidification device is a device for solidifying the liquid droplets to form a toner.

The solidification treatment is not limited to any particular procedure so long as the toner composition liquid can be solidified, and is selected in accordance with the property of the toner composition liquid. For example, when the toner composition liquid is comprised of a volatile solvent in which raw materials are dissolved or dispersed, the discharged liquid droplets can be solidified by drying the liquid droplets in a carrier gas flow, in other words, evaporating the solvent. The drying condition is controllable by controlling the temperature of the injection gas, vapor pressure, and kind of the gas. The liquid droplets need not necessarily be completely dried so long as the collected particles are kept in a solid state. In this case, the collected particles may be subject to an additional drying process. Alternatively, the solidification treatment may involve thermal change or a chemical reaction.

In the collection treatment, the solidified particles can be collected by any powder collector, such as a cyclone collector or a back filter.

One example of an apparatus for manufacturing the toner according to some embodiments of the present invention is described in detail below with reference to FIG. 3.

A toner manufacturing apparatus 1 has a liquid droplet discharge device 2 and a drying collecting unit 60.

The liquid droplet discharge device 2 is connected to a raw material container 13 containing the toner composition liquid 14 through a liquid supply pipe 16 to supply the toner composition liquid 14 from the raw material container 13 to the liquid droplet discharge device 2. The liquid droplet discharge device 2 is further connected to a liquid return pipe 22 to return the toner composition liquid 14 to the raw material container 13, and a liquid circulating pump 15 to pump the toner composition liquid 14 within the liquid supply pipe 16. Thus, the toner composition liquid 14 can be constantly supplied to the liquid droplet discharge device 2. The liquid supply pipe 16 and the drying collecting unit 60 are equipped with pressure gauges P1 and P2, respectively. The pressure gauges P1 and P2 monitor the liquid feed pressure toward the liquid droplet discharge device 2 and the inner pressure of the drying collecting unit 60, respectively. When the pressure measured by the pressure gauge P1 is greater than that measured by the pressure gauge P2 (i.e., P1>P2), there is a concern that the toner composition liquid 14 leaks from the discharge holes. When the pressure measured by the pressure gauge P1 is smaller than that measured by the pressure gauge P2 (i.e., P1<P2), there is a concern that a gas flows in the liquid droplet discharge device 2 and the liquid droplet discharge phenomenon is stopped. Thus, preferably, the pressure measured by the pressure gauge P1 is nearly identical to that measured by the pressure gauge P2.

Within a chamber 61, a conveyance airflow 101 is formed through a conveyance airflow inlet 64. Liquid droplets 21 discharged from the liquid droplet discharge device 2 are conveyed downward by the action of gravity as well as the conveyance airflow 101 and collected by a solidified particle collector 62.

### Conveyance Airflow

If the injected liquid droplets are brought into contact with each other before being dried, the liquid droplets coalesce with each other to form a single particle. (This phenomenon is hereinafter referred to as “coalescence”.) To obtain solidified particles having a uniform particle diameter distribution, it is preferable that the distance between the injected liquid droplets is kept constant. Although the initial velocity is constant, the injected liquid droplet is gradually stalled due to air resistance. As a result, a posterior liquid droplet may catch up on and coalesce with the stalled particle. Because this phenomenon occurs constantly, the particle diameter distribution of the resulting collected particles may become undesirably wide. To prevent coalescence of liquid droplets, liquid droplets should be conveyed to the solidified particle collector 62 by the conveyance airflow 101 while being solidified without being stalled or brought into contact with each other.

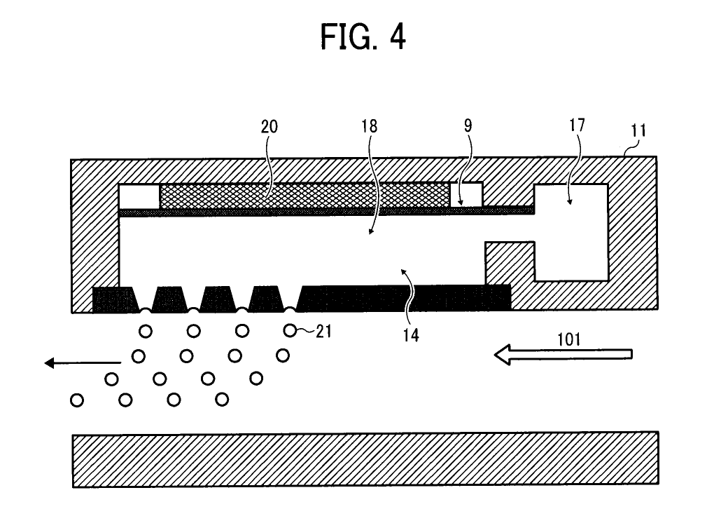

Referring to FIG. 2, a part of the conveyance airflow 101 (hereinafter maybe referred to as “first airflow”) can flow near the liquid droplet discharge device in the same direction as the direction of discharge of liquid droplets, so as to prevent speed decrease of the liquid droplets immediately after the discharge to prevent coalescence of the liquid droplets. Alternatively, the first airflow can flow in a direction lateral to the direction of discharge of liquid droplets, as illustrated in FIG. 4. Alternatively, the first airflow can flow at a certain angle with the liquid droplet discharge device such that the liquid droplets are brought away from the liquid droplet discharge device. In a case in which the first airflow (hereinafter maybe referred to as “coalescence preventing airflow”) flows in a direction lateral to the direction of discharge of liquid droplets, as illustrated in FIG. 4, it is preferable that the first airflow convey liquid droplets in a manner such that the travel path of each liquid droplet starting from any discharge hole will not intercept that of another liquid droplet.

It is also possible that coalescence of the liquid droplets is prevented by the first airflow and the solidified particles are conveyed to the toner collector by the second airflow.

It is preferable that the speed of the first airflow be equal to or more than the liquid droplet injection speed. If the speed of the first airflow is smaller than the liquid droplet injection speed, it is difficult for the first airflow (coalescence preventing airflow) to achieve its purpose, i.e., to prevent coalescence of the liquid droplets.

The first airflow can have any additional property for preventing coalescence of the liquid droplets and does not necessarily have the same property as the second airflow. In the first airflow (coalescence preventing airflow), a chemical substance which accelerates solidification of the liquid droplets can be mixed. Additionally, the first airflow (coalescence preventing airflow) can be physically treated to have a function of accelerating solidification of the liquid droplets.

The conveyance airflow 101 is not limited in condition, and may be, for example, a laminar flow, a swirl flow, or a turbulent flow. The conveyance airflow 101 is not limited in substance, and may be formed of, for example, the air or a noncombustible gas such as nitrogen. The temperature of the conveyance airflow 101 is variable but is preferably constant during the manufacturing operation. The chamber 61 may further include a unit for varying the condition of the conveyance airflow 101. The conveyance airflow 101 may prevent not only the coalescence of the liquid droplets 21 but also the adhesion of the liquid droplets 21 to the chamber 61.

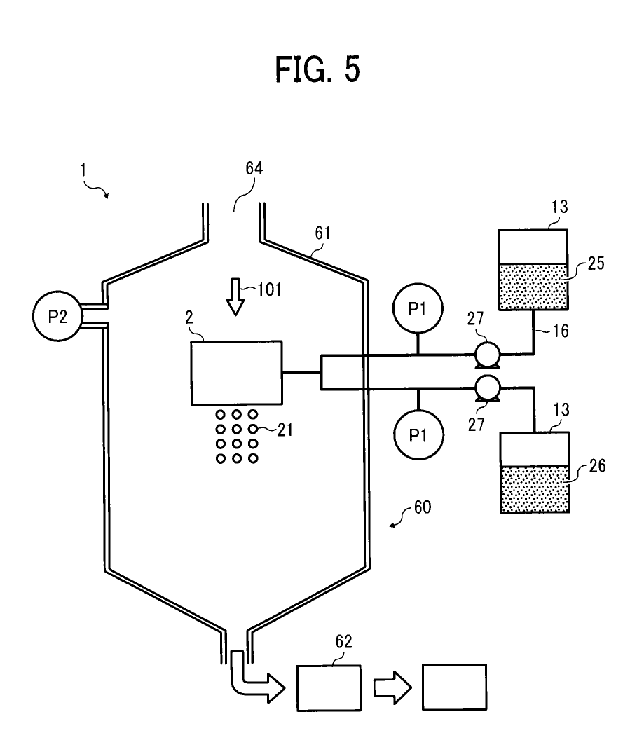

Another example of an apparatus for manufacturing the toner according to some embodiments of the present invention is described in detail below with reference to FIG. 5. The same reference number is given to identical elements in FIGS. 2 and 5.

In the embodiment illustrated in FIG. 5, a colorant dispersion liquid 26 and a toner composition liquid 25 (containing no colorant) are mixed immediately before they are supplied to the liquid droplet discharge device 2. Alternatively, it is possible to mix the colorant dispersion liquid 26 and the toner composition liquid 25 (containing no colorant) in advance and supply the mixture to the liquid droplet discharge device 2. However, this procedure is unsuitable for a long-term continuous collection. Immediately after the two liquids are mixed, no problem will arise. However, several hours after the mixing, colorant aggregation will occur from the influence of wax and/or charge controlling agent, causing nozzle clogging and defective discharge. As a result, the resulting toner particles will contain ultrafine particles. In other words, the resulting toner particles have a wide particle diameter distribution. The apparatus illustrated in FIG. 5 is capable of producing a toner having a narrow particle diameter distribution.

### Other Processes

The method of manufacturing the toner according to some embodiments of the present invention may include a secondary drying process.

When toner particles collected in the drying collecting unit 62 illustrated in FIG. 3 contain a large amount of residual solvent, the toner particles can be optionally subjected to a secondary drying to reduce the amount residual solvent.

The secondary drying can be performed by any drier, such as a fluidized-bed drier or a vacuum drier. If residual solvent is remaining in the toner particles, toner properties such as heat-resistant storage stability, fixability, and chargeability may deteriorate with time. Moreover, when such toner particles are fixed on a recording material by application of heat, the solvent volatilizes with increasing a possibility of adversely affecting users and peripheral devices.

### Developer

The developer according to some embodiments of the present invention includes at least the above-described toner and optionally other components such as a carrier.

### Carrier

Specific examples of the carrier include, but are not limited to, a ferrite carrier, a magnetite carrier, and a resin-coated carrier.

The resin-coated carrier is composed of a core particle and a covering material that is a resin for covering the core particle.

Depending on the surface roughness of the carrier and the content of the covering material, the carrier preferably has a volume resistivity of from 10⁶ to 10¹⁰ Ω·cm.

The carrier preferably has an average particle diameter of from 4 to 200 μm.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### Example 1

### Preparation of Toner 1

### Preparation of Colorant Dispersion Liquid

A carbon black dispersion liquid is prepared as follows.

First, 8.0 parts of a carbon black (REGAL 400 from Cabot Corporation) and 12 parts of a colorant dispersant (RSE-801T from Sanyo Chemical Industries, Ltd.) are primarily dispersed in 80 parts of ethyl acetate using a mixer having stirrer blades. The resulting primary dispersion liquid is subjected to a dispersion treatment using a DYNOMILL to more finely disperse the carbon black and completely remove aggregations by application of a strong shearing force. The resulting secondary dispersion liquid is filtered with a polytetrafluoroethylene (PTFE) filter (Fluoropore™ Membrane Filter FHLP09050 available from Nihon Millipore K.K.) having a pore size of 0.45 μm to further disperse the carbon black to submicron range. Thus, a carbon black dispersion liquid is prepared.

### Preparation of Toner Composition Liquid (Containing No Colorant)

First, 2.8 parts of a wax 1, serving as the release agent, 36.7 parts of a polyester resin A and 2.2 parts of a crystalline polyester resin A′, both serving as the binder resin, and 0.7 parts of a charge controlling agent (FCA-N) are mixed and dissolved in 919.2 parts of ethyl acetate using a mixer having stirrer blades at 70° C. All the materials are dissolved in the ethyl acetate without causing phase separation and a transparent liquid is obtained. By adjusting the temperature of the liquid to 55° C., a toner composition liquid (containing no colorant) is prepared.

The wax 1 is a paraffin wax (available from Nippon Seiro Co., Ltd.) having a melting point of 68.0° C.

The polyester resin A is a resin composed of terephthalic acid, isophthalic acid, succinic acid, ethylene glycol, and neopentyl glycol, having a weight average molecular weight (Mw) of 24,000 and a glass transition temperature (Tg) of 60° C.

The crystalline polyester resin A′ is a crystalline resin composed of sebacic acid and hexanediol, having a weight average molecular weight (Mw) of 13,000 and a glass transition temperature (Tg) of 70° C. The weight average molecular weight (Mw) of the binder resin is determined by subjecting THF solubles in the binder resin to a measurement by a gel permeation chromatographic apparatus GPC-150C (available from Waters Corporation) equipped with Shodex® Columns KF801-807 (available from Showa Denko K.K.) and a refractive index (RI) detector. The boiling point of ethyl acetate is 76.8° C.

The charge controlling agent FCA-N is available from Fujikura Kasei Co., Ltd.

### Preparation of Mother Toner Particles

A toner is prepared as follows using the toner manufacturing apparatus illustrated in FIG. 5.

In this apparatus, a colorant dispersion liquid 26 and a toner composition liquid 25 (containing no colorant) are mixed immediately before they are supplied to the liquid droplet discharge device 2.

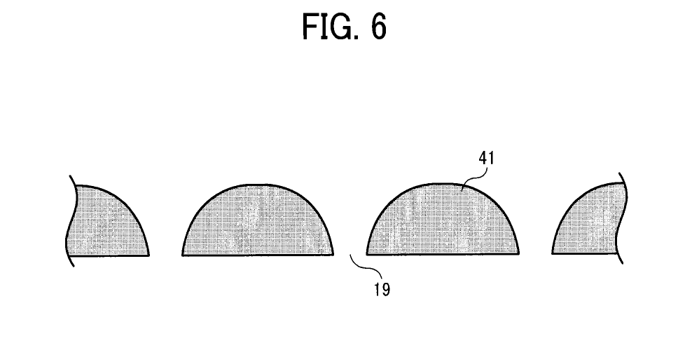

In particular, 38.5 parts of the above-prepared carbon black dispersion liquid and 961.6 parts the above-prepared toner composition liquid (containing no colorant) are supplied to the liquid droplet discharge device 2 by liquid feeders 27. Syringe pumps are used as the liquid feeders 27. The liquid droplet discharge device 2 has a liquid discharge head having a cross-sectional view illustrated in FIG. 6. The measuring conditions are listed below. The temperature of the vessel installed in the toner manufacturing apparatus in which the colorant dispersion liquid 26 and the toner composition liquid 25 (containing no colorant) are mixed is set to 55° C.

After the liquid droplet discharge device 2 discharges liquid droplets, the liquid droplets are dried and solidified by a liquid droplet solidification treatment using dry nitrogen. The solidified particles are collected by a cyclone collector and fan-dried at 35° C., 90% RH for 48 hours and at 40°, 50% RH for 24 hours. Thus, mother toner particles are obtained.

The toner manufacturing apparatus is continuously operated for 24 hours without causing discharge hole clogging.

### Manufacture Conditions

Longitudinal length (L) of liquid column resonance liquid chamber: 1.85 mm

Diameter of discharge hole outlet: 10.0 μm

Drying temperature (nitrogen): 60° C.

Drive frequency: 340 kHz

Applied voltage to piezoelectric body: 10.0 V

Next, 100 parts of the mother toner particles are mixed with commercially-available silica powders, i.e., 2.8 parts of NAX50 (from Nippon Aerosil Co., Ltd., having an average primary diameter of 30 nm) and 0.9 parts of H20TM (from Clariant, having an average primary diameter of 20 nm), using a HENSCHEL MIXER. The mixture is passed through a sieve having an opening of 60 μm to remove coarse particles or aggregations. Thus, a toner 1 is prepared.

The composition of the mother toner particles of the toner 1 is described in Table 2-1.

The toner 1 is subjected to an analysis by a flow particle image analyzer FPIA-3000 (from Sysmex Corporation) under the below-described analysis conditions to determine average circularity Rave., mode particle diameter (number-based) θmax, the ratio of the number of particles having a particle diameter equal to or less than 0.75 times the mode particle diameter θmax and a circularity equal to or more than 0.980 to the number of limited particles, and the standard deviation of the count number. The results are shown in Table 3-1.

### Analysis Conditions

1) Particle diameter analysis range is limited to 1.985 (μm)≦equivalent circle diameter (number based)<200.0 (μm).
2) Particle shape analysis range is limited to 0.200≦circularity≦1.000.
3) The number of limited particles satisfying the conditions 1) and 2) is limited to from 4,800 to 5,200.

The amount of the wax (release agent) extracted from the toner 1 with n-hexane is measured in the manner described below. The results are shown in Table 3-1.

### Measurement Procedure for Amount of Extracted Wax

The amount of the extracted wax is measured as follow with reference to the predetermined values listed in Table 1.

TABLE 1

| | Set Value | | Allowable Tolerance |
|---|---|---|---|
| Predetermined Value 1 | 1.00 | g | +0.01 g, −0.00 g |
| Predetermined Value 2 | 4.60 | g | +0.03 g, −0.00 g |
| Predetermined Value 3 | Scale 5 | | — |
| Predetermined Value 4 | 1 | min | — |
| Predetermined Value 5 | 4,000 rpm, 1 sec | | — |
| Predetermined Value 6 | 3.00 | g | +0.02 g, −0.00 g |
| Predetermined Value 7 | 0.02 | MPa | — |
| Predetermined Value 8 | 2 | min | — |

1) A predetermined amount (predetermined value 2) of hexane is weighed in a centrifuge tube with a Dispensette®.
2) A predetermined amount (predetermined value 1) of a toner is weighed on a weighing paper with a weighing equipment.
3) The centrifuge tube is charged with the toner on a test tube rack and covered with a lid.
4) The centrifuge tube is subjected to a stirring by a vortex mixer while setting the scale to the predetermined value 3 and the stirring time to the predetermined value 4.
5) The centrifuge tube is set in a centrifuge while setting the rotational number and retention time to the predetermined value 5 to precipitate the toner.
6) The weight (X) of an aluminum cup with a handle is measured.
7) The aluminum cup with a handle is charged with a predetermined amount (predetermined value 6) of the supernatant liquid and put in a vacuum drier at 150° C.
8) The pressure scale of the vacuum drier is set to the predetermined value 7. It takes 5 minutes to evaporate the hexane.
9) The aluminum cup with a handle is taken out from the vacuum drier and cooled in a desiccator for a predetermined amount (predetermined value 8) of time.
10) The weight (Y) of the aluminum cup with a handle is measured.
11) The amount of the extracted wax is determined from the following formula (1):

Amount of Extracted Wax(mg)=(Weight of Aluminum Cup(Y)−Weight of Aluminum Cup(X))×1,000×4.6/3 (1)

### DSC Measurement of Extracted Wax

After the measurement of the amount of the extracted wax, the wax remaining in the aluminum cup is subjected to a measurement of endothermic peak (melting peak) by differential scanning calorimetry (DSC). The measurement is performed based on a method according to ASTM D3418-82. In the measurement, the wax is preliminarily heated and cooled once to remove its thermal history and then heated at a heating rate of 10° C./min.

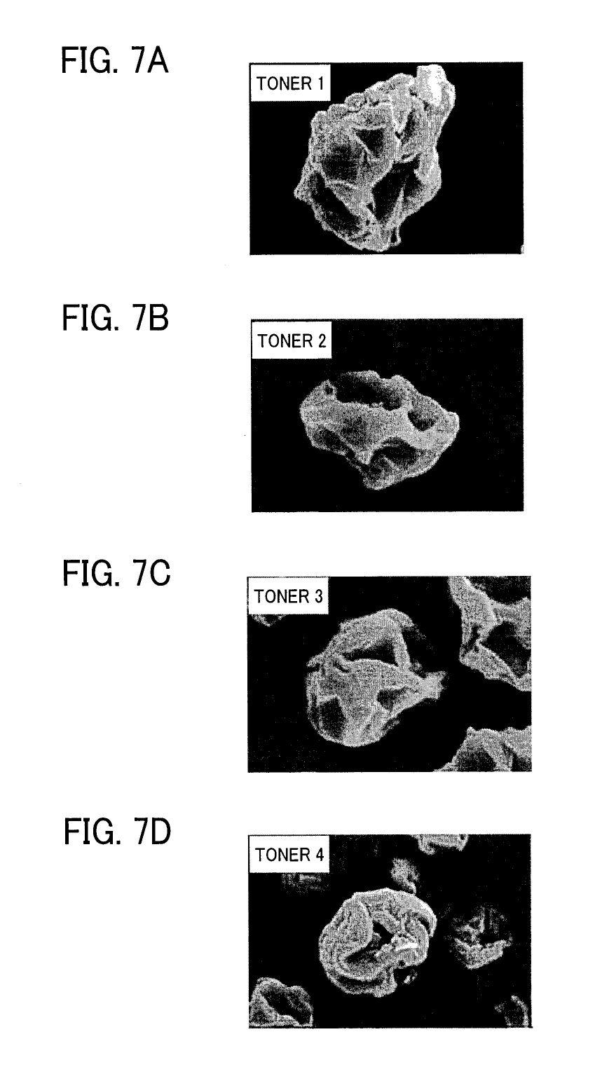

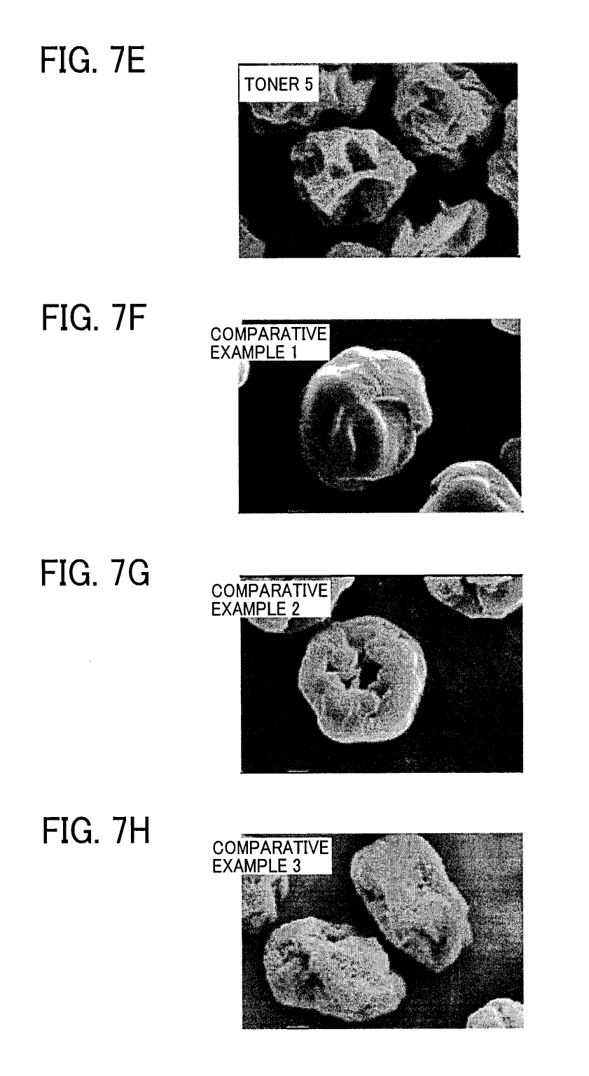

FIG. 7A is a scanning electron microscope (SEM) image of the toner 1.

### Preparation of Developer

A developer 1 is prepared by mixing 5 parts of the toner 1 and 95 parts of a carrier prepared in the manner described below with a TURBULA MIXER (from SHINMARU ENTERPRISES CORPORATION).

### Preparation of Carrier

A mixture of 100 parts of a silicone resin (organo straight silicone), 100 parts of toluene, 5 parts of γ-(2-aminoethyl)aminopropyl trimethoxysilane, and 10 parts of a carbon black is subjected to a dispersion treatment for 20 minutes using a HOMOMIXER to prepare a coating layer forming liquid. The coating layer forming liquid is applied to the surfaces of 1,000 parts of spherical magnetite particles having a particle diameter of 50 μm using a fluidized-bed coating device. Thus, a magnetic carrier is prepared.

The developer 1 is set in an image forming apparatus and subjected to the evaluations described below. The results are shown in Table 3-1.

### Evaluation of Cleanability

The developer is set in a copier (IMAGIO MP7501 from Ricoh Co., Ltd.), and cleanability is evaluated as follows.

After a toner image having an image area ratio of 30% is developed on a photoconductor and transferred onto a paper sheet, and while the cleaning blade is removing residual toner particles remaining on the photoconductor, the operation of the copier is stopped. The residual toner particles remaining on the photoconductor and passed through the cleaning blade are transferred onto a white paper sheet with SCOTCH TAPE (from Sumitomo 3M Limited). Ten randomly selected portions thereon are subjected to a measurement of image density by a Macbeth reflective densitometer RD514. Cleanability is evaluated in terms of the difference between the average image density of 10 measured values and the blank image density that is a measured value for SCOTCH TAPE adhered to the white paper sheet, according to the following criteria.

The cleaning blade having been already spent in 20,000-sheet printing is used.

### Evaluation Criteria

AA (Very good): The difference is not greater than 0.010.

A (Good): The difference is greater than 0.010 and not greater than 0.015.

C (Poor): The difference is greater than 0.015.

### Evaluation of Transferability

The developer 1 is set in a copier (IMAGIO MP7501 from Ricoh Co., Ltd.) whose linear speed and transfer time have been tuned to 162 mm/sec and 40 msec, respectively. A running test in which an A4-size solid pattern image having a toner deposition amount of 0.6 mg/cm² is continuously printed is performed. After the initial and 100,000th images are printed, the primary transfer efficiency and secondary transfer efficiency are determined from the following formulae (2) and (3), respectively.

Primary Transfer Efficiency (%)=(Amount of Toner Transferred onto Intermediate Transfer Medium)/(Amount of Toner Developed on Photoconductor) (2)

Secondary Transfer Efficiency (%)=((Amount of Toner Transferred onto Intermediate Transfer Medium)−(Amount of Residual Toner Remaining on Intermediate Transfer Medium))/(Amount of Toner Transferred onto Intermediate Transfer Medium) (3)

### Evaluation Criteria

Transferability is evaluated in terms of the average of the primary transfer efficiency and the secondary transfer efficiency based on the following criteria.

AA: not less than 90%

A: not less than 85% and less than 90%

C: less than 85%

### Evaluation of Fixable Temperature Range

The developer 1 is set in a tandem-type full-color image forming apparatus. A solid image with a toner deposition amount of 0.85±0.10 mg/cm² and an image size of 3 cm×8 cm is formed on sheets of a transfer paper (TYPE 6200 from Ricoh Japan Co., Ltd.) and fixed on each sheet at various fixing belt temperatures. The fixed images are visually observed to determine whether hot offset is occurring or not. The fixable temperature range is determined from the difference between the upper-limit temperature at which offset does not occur and the lower-limit fixable temperature. The solid image is formed on the sheet 3.0 cm away from the leading edge in the paper feeding direction. The speed at which the sheet passes through the nip portion of the fixing device is 280 mm/s. A wider fixable temperature range indicates a better hot offset resistance. The average fixable temperature range for conventional full-color toner is about 50° C.

### Evaluation Criteria

AA: not less than 50° C.

A: not less than 40° C. and less then 50° C.

B: not less than 30° C. and less than 40° C.

C: less than 30° C.

### Example 2

The procedure in Example 1 is repeated except for changing the procedures for preparing the toner composition liquid (containing no colorant) and mother toner particles as described below. Thus, a toner 2 is prepared.

The composition of the mother toner particles of the toner 2 is described in Table 2-1.

### Preparation of Toner Composition Liquid (Containing No Colorant)

First, 16.8 parts of a wax 2, serving as the release agent, 62.2 parts of the polyester resin A and 4.4 parts of the crystalline polyester resin A′, both serving as the binder resin, and 1.4 parts of the charge controlling agent (FCA-N) are mixed and dissolved in 838.4 parts of ethyl acetate using a mixer having stirrer blades at 70° C. All the materials are dissolved in the ethyl acetate without causing phase separation and a transparent liquid is obtained. By adjusting the temperature of the liquid to 55° C., a toner composition liquid (containing no colorant) is prepared.

The wax 2 is an ester wax (available from Sanyo Chemical Industries, Ltd.) having a melting point of 70.0° C.

### Preparation of Mother Toner Particles

The procedure in Example 1 is repeated except for changing the diameter of the discharge hole outlet in the liquid droplet discharge head to 8.0 μm.

The toner 2 is subjected to various measurements and evaluations in the same manner as Example 1. The results are shown in Table 3-1. FIG. 7B is a scanning electron microscope (SEM) image of the toner 2.

### Example 3

The procedure in Example 2 is repeated except for changing the procedure for preparing the toner composition liquid (containing no colorant) as described below. Thus, a toner 3 is prepared.

The composition of the mother toner particles of the toner 3 is described in Table 2-1.

### Preparation of Toner Composition Liquid (Containing No Colorant)

The procedure in Example 2 is repeated except for replacing the wax 2 with a wax 3.

The wax 3 is an ester wax (available from NOF Corporation) having a melting point of 64.1° C.

The toner 3 is subjected to various measurements and evaluations in the same manner as Example 1. The results are shown in Table 3-1. FIG. 7C is a scanning electron microscope (SEM) image of the toner 3.

### Example 4

The procedure in Example 2 is repeated except for changing the procedure for preparing the toner composition liquid (containing no colorant) as described below (i.e., the addition amount of the wax 2 is changed). Thus, a toner 4 is prepared.

The composition of the mother toner particles of the toner 4 is described in Table 2-1.

### Preparation of Toner Composition Liquid (Containing No Colorant)

First, 11.2 parts of the wax 2, serving as the release agent, 67.8 parts of the polyester resin A and 4.4 parts of the crystalline polyester resin A′, both serving as the binder resin, and 1.4 parts of the charge controlling agent (FCA-N) are mixed and dissolved in 838.4 parts of ethyl acetate using a mixer having stirrer blades at 70° C. All the materials are dissolved in the ethyl acetate without causing phase separation and a transparent liquid is obtained. By adjusting the temperature of the liquid to 55° C., a toner composition liquid (containing no colorant) is prepared.

The wax 2 is an ester wax (available from Sanyo Chemical Industries, Ltd.) having a melting point of 70.0° C.

The toner 4 is subjected to various measurements and evaluations in the same manner as Example 1. The results are shown in Table 3-1. FIG. 7D is a scanning electron microscope (SEM) image of the toner 4.

### Example 5

The procedure in Example 2 is repeated except for changing the procedure for preparing the toner composition liquid (containing no colorant) as described below. Thus, a toner 5 is prepared.

The composition of the mother toner particles of the toner 5 is described in Table 2-1.

### Preparation of Toner Composition Liquid (Containing No Colorant)

The procedure in Example 2 is repeated except for replacing the wax 2 with a wax 4.

The wax 4 is a paraffin wax (available from Tokyo Chemical Industry Co., Ltd.) having a melting point of 67.1° C.

The toner 5 is subjected to various measurements and evaluations in the same manner as Example 1. The results are shown in Table 3-1. FIG. 7E is a scanning electron microscope (SEM) image of the toner 5.

### Example 6

The procedure in Example 2 is repeated except for changing the procedure for preparing the toner composition liquid (containing no colorant) as described below. Thus, a toner 6 is prepared.

The composition of the mother toner particles of the toner 6 is described in Table 2-1.

### Preparation of Toner Composition Liquid (Containing No Colorant)

The procedure in Example 2 is repeated except for replacing the wax 2 with a mixture of the wax 2 and the wax 3. The toner 6 is subjected to various measurements and evaluations in the same manner as Example 1. The results are shown in Table 3-1.

### Example 7

The procedure in Example 2 is repeated except for changing the procedure for preparing the toner composition liquid (containing no colorant) as described below. Thus, a toner 7 is prepared.

The composition of the mother toner particles of the toner 7 is described in Table 2-1.

### Preparation of Toner Composition Liquid (Containing No Colorant)

The procedure in Example 2 is repeated except for replacing the wax 2 with a mixture of the wax 3 and a wax 5. The wax 5 is an ester wax (available from NOF Corporation) having a melting point of 83.1° C.

The toner 7 is subjected to various measurements and evaluations in the same manner as Example 1. The results are shown in Table 3-1.

### Example 8

The procedure in Example 2 is repeated except for changing the procedure for preparing the toner composition liquid (containing no colorant) as described below. Thus, a toner 8 is prepared.

The composition of the mother toner particles of the toner 8 is described in Table 2-2.

### Preparation of Toner Composition Liquid (Containing No Colorant)

The procedure in Example 2 is repeated except for replacing the wax 2 with a mixture of the wax 2 and a wax 6. The wax 6 is an ester wax (available from NOF Corporation) having a melting point of 55.2° C.

The toner 8 is subjected to various measurements and evaluations in the same manner as Example 1. The results are shown in Table 3-2.

### Example 9

The procedure in Example 2 is repeated except for changing the procedure for preparing the toner composition liquid (containing no colorant) as described below. Thus, a toner 9 is prepared.

The composition of the mother toner particles of the toner 9 is described in Table 2-2.

### Preparation of Toner Composition Liquid (Containing No Colorant)

The procedure in Example 2 is repeated except for replacing the wax 2 with a mixture of the wax 3 and a wax 7. The wax 7 is a paraffin wax (available from Nippon Seiro Co., Ltd.) having a melting point of 76.9° C.

The toner 9 is subjected to various measurements and evaluations in the same manner as Example 1. The results are shown in Table 3-2.

### Example 10

The procedure in Example 2 is repeated except for changing the procedure for preparing the toner composition liquid (containing no colorant) as described below. Thus, a toner 10 is prepared.

The composition of the mother toner particles of the toner 10 is described in Table 2-2.

### Preparation of Toner Composition Liquid (Containing No Colorant)

The procedure in Example 2 is repeated except for replacing the wax 2 with a mixture of the wax 5 and the wax 6. The toner 10 is subjected to various measurements and evaluations in the same manner as Example 1. The results are shown in Table 3-2.

### Example 11

The procedure in Example 2 is repeated except for changing the procedure for preparing the toner composition liquid (containing no colorant) as described below. Thus, a toner 11 is prepared.

The composition of the mother toner particles of the toner 11 is described in Table 2-2.

### Preparation of Toner Composition Liquid (Containing No Colorant)

The procedure in Example 2 is repeated except for replacing the wax 2 with a mixture of the wax 2 and the wax 7. The toner 11 is subjected to various measurements and evaluations in the same manner as Example 1. The results are shown in Table 3-2.

### Example 12

The procedure in Example 2 is repeated except for changing the procedure for preparing the toner composition liquid (containing no colorant) as described below. Thus, a toner 12 is prepared.

The composition of the mother toner particles of the toner 12 is described in Table 2-2.

### Preparation of Toner Composition Liquid (Containing No Colorant)

The procedure in Example 2 is repeated except for replacing the wax 2 with a mixture of the wax 2 and the wax 5. The toner 12 is subjected to various measurements and evaluations in the same manner as Example 1. The results are shown in Table 3-2.

### Example 13

The procedure in Example 2 is repeated except for changing the procedure for preparing the toner composition liquid (containing no colorant) as described below. Thus, a toner 13 is prepared.

The composition of the mother toner particles of the toner 13 is described in Table 2-2.

### Preparation of Toner Composition Liquid (Containing No Colorant)

The procedure in Example 2 is repeated except for replacing the wax 2 with a mixture of the wax 1 and the wax 7. The toner 13 is subjected to various measurements and evaluations in the same manner as Example 1. The results are shown in Table 3-2.

### Comparative Example 1

The procedure in Example 2 is repeated except for changing the procedure for preparing the toner composition liquid (containing no colorant) as described below (i.e., no wax is added). Thus, a comparative toner 1 is prepared.

The composition of the mother toner particles of the comparative toner 1 is described in Table 2-3.

### Preparation of Toner Composition Liquid (Containing No Colorant)

First, 79.0 parts of the polyester resin A and 4.4 parts of the crystalline polyester resin A′, both serving as the binder resin, and 1.4 parts of the charge controlling agent (FCA-N) are mixed and dissolved in 838.4 parts of ethyl acetate using a mixer having stirrer blades at 70° C. All the materials are dissolved in the ethyl acetate without causing phase separation and a transparent liquid is obtained. By adjusting the temperature of the liquid to 55° C., a toner composition liquid (containing no colorant) is prepared.

The comparative toner 1 is subjected to various measurements and evaluations in the same manner as Example 1. The results are shown in Table 3-3. FIG. 7F is a scanning electron microscope (SEM) image of the comparative toner 1.

### Comparative Example 2

The procedure in Example 2 is repeated except for changing the procedure for preparing the toner composition liquid (containing no colorant) as described below (i.e., a clay mineral is added). Thus, a comparative toner 2 is prepared.

The composition of the mother toner particles of the comparative toner 2 is described in Table 2-3.

### Preparation of Toner Composition Liquid (Containing No Colorant)

First, 5.6 parts of the wax 2, serving as the release agent, 56.6 parts of the polyester resin A and 4.4 parts of the crystalline polyester resin A′, both serving as the binder resin, 1.4 parts of the charge controlling agent (FCA-N), and 16.8 parts of a clay mineral (SPN from Co-op Chemical Co., Ltd.) are mixed and dissolved in 838.4 parts of ethyl acetate using a mixer having stirrer blades at 70° C. All the materials are dissolved or dispersed in the ethyl acetate without causing phase separation and a transparent liquid is obtained. By adjusting the temperature of the liquid to 55° C., a toner composition liquid (containing no colorant) is prepared.

The comparative toner 2 is subjected to various measurements and evaluations in the same manner as Example 1. The results are shown in Table 3-3. FIG. 7G is a scanning electron microscope (SEM) image of the comparative toner 2.

### Comparative Example 3

Mother toner particles are prepared by an emulsion method as described below.

### Preparation of Fine Particle Emulsion

A reaction vessel equipped with a stirrer and a thermometer is charged with 683 parts of water, 11 parts of a sodium salt of a sulfate of ethylene oxide adduct of methacrylic acid (ELEMINOL RS-30 from Sanyo Chemical Industries, Ltd.), 83 parts of styrene, 83 parts of methacrylic acid, 110 parts of butyl acrylate, and 1 part of ammonium persulfate. The mixture is agitated at a revolution of 400 rpm for 15 minutes, thus preparing a white emulsion. The white emulsion is heated to 75° C. and subjected to a reaction for 5 hours. Further, 30 parts of 1% aqueous solution of ammonium persulfate are added to the emulsion, and the mixture is aged at 75° C. for 5 hours. Thus, a fine particle dispersion liquid that is an aqueous dispersion liquid of a vinyl resin (i.e., a copolymer of styrene, methacrylic acid, butyl acrylate, and a sodium salt of a sulfate of ethylene oxide adduct of methacrylic acid) is prepared.

The volume average particle diameter of the fine particle dispersion measured by a particle size distribution analyzer (LA-920 from Horiba, Ltd.) is 105 nm. A part of the fine particle dispersion is dried to isolate the resin component. The isolated resin component has a glass transition temperature (Tg) of 59° C. and a weight average molecular weight (Mw) of 150,000.

### Synthesis of Polyester Resin

A reaction vessel equipped with a condenser, a stirrer, and a nitrogen inlet pipe is charged with 229 parts of ethylene oxide 2 mol adduct of bisphenol A, 529 parts of propylene oxide 3 mol adduct of bisphenol A, 208 parts of terephthalic acid, 46 parts of adipic acid, and 2 parts of dibutyltin oxide. The mixture is subjected to a reaction at 230° C. for 8 hours under normal pressures and subsequent 5 hours under reduced pressures of from 10 to 15 mmHg. Thereafter, 30 parts of trimellitic anhydride are added to the vessel, and the mixture is subjected to a reaction at 180° C. for 2 hours under normal pressures. Thus, a polyester resin is prepared. The polyester resin has a weight average molecular weight (Mw) of 6,700, a glass transition temperature (Tg) of 43° C., and an acid value of 20 mgKOH/g.

### Preparation of Aqueous Phase

An aqueous phase is prepared by mixing 990 parts of water, 183 parts of the fine particle dispersion, 37 parts of a 48.5% aqueous solution of dodecyl diphenyl ether sodium disulfonate (ELEMINOL MON-7 from Sanyo Chemical Industries, Ltd.), and 90 parts of ethyl acetate. The aqueous phase is a milky whitish liquid.

### Synthesis of Low-Molecular-Weight Polyester

A reaction vessel equipped with a condenser, a stirrer, and a nitrogen inlet pipe is charged with 682 parts of ethylene oxide 2 mol adduct of bisphenol A, 81 parts of propylene oxide 2 mol adduct of bisphenol A, 283 parts of terephthalic acid, 22 parts of trimellitic anhydride, and 2 parts of dibutyltin oxide. The mixture is subjected to a reaction at 230° C. for 5 hours under normal pressures. Thus, a low-molecular-weight polyester is prepared.

The low-molecular-weight polyester has a number average molecular weight (Mn) of 2,100, a weight average molecular weight (Mw) of 9,500, a glass transition temperature (Tg) of 55° C., an acid value of 0.5 mgKOH/g, and a hydroxyl value of 51 mgKOH/g.

### Synthesis of Modified Polyester Having Reactive Substituent

A reaction vessel equipped with a condenser, a stirrer, and a nitrogen inlet pipe is charged with 410 parts of the low-molecular-weight polyester, 89 parts of isophorone diisocyanate, and 500 parts of ethyl acetate. The mixture is subjected to a reaction for 5 hours at 100° C. Thus, a modified polyester having a reactive substituent is prepared.

The content of free isocyanates in the modified polyester having a reactive substituent is 1.53%.

### Preparation of Cyan Master Batch

First, 1,200 parts of water, 270 parts of a colorant C.I. PB 15:3 (from Dainichiseika Color & Chemicals Mfg. Co., Ltd.), 8 parts of a pigment derivative SOLSPERSE 5000 (from The Lubrizol Corporation), and 1,200 parts of the polyester resin are mixed by a HENSCHEL MIXER (from Mitsui Mining & Smelting Co., Ltd.). The mixture is kneaded by a double roll for 30 minutes at 150° C., the kneaded mixture is cooled by rolling and then pulverized by a pulverizer (from Hosokawa Micron Corporation). Thus, a master batch is prepared.

### Preparation of Organic Solvent Phase

A reaction vessel equipped with a stirrer and a thermometer is charged with 378 parts of the polyester resin, 110 parts of a carnauba wax, and 947 parts of ethyl acetate. The mixture is heated to 80° C. under stirring, kept at 80° C. for 30 hours, and cooled to 30° C. over a period of 1 hour. Thus, a raw material liquid is prepared.

Thereafter, 1,324 parts of the raw material liquid are subjected to a dispersion treatment using a bead mill (ULTRAVISCOMILL (trademark) from Aimex Co., Ltd.) filled with 80% by volume of zirconia beads having a diameter of 0.5 mm at a liquid feeding speed of 1 kg/hour and a disc peripheral speed of 6 m/sec for 9 hours, to disperse the carnauba wax.

The resulting dispersion liquid is mixed with 1,324 parts of a 65% ethyl acetate solution of the low-molecular-weight polyester, 500 parts of the master batch, and 500 parts of ethyl acetate for 1 hour. The mixture liquid is kept at 25° C. and passed through an EBARA MILDER (combination of G, M, S from the entry side) at a flow rate of 1 kg/min for 4 times (4 passes). Thus, an organic solvent phase (colorant wax dispersion liquid) is prepared.

The solid content concentration (130°, 30 minutes) in the organic solvent phase is 50%.

### Emulsification and Dispersion

A reaction vessel is charged with 749 parts of the organic solvent phase, 115 parts of the modified polyester having a reactive substituent, and 2.9 parts of isophoronediamine (from Wako Pure Chemical Industries, Ltd.). These materials are mixed by a homomixer (TK HOMOMIXER MKII from PRIMIX Corporation) at a revolution of 5,000 rpm for 1 minute. After 1,200 parts of the aqueous phase are added to the reaction vessel, the materials are mixed by the homomixer at a revolution of 9,000 rpm for 3 minutes. The mixture is stirred by a stirrer for 20 minutes. Thus, an emulsion slurry is prepared.

The emulsion slurry is contained in a reaction vessel equipped with a stirrer and a thermometer and subjected to solvent removal at 25° C. After the organic solvent has been removed, an aging treatment is performed at 45° C. for 15 hours. Thus, a dispersion slurry is obtained.

### Washing Process

First, 100 parts of the dispersion slurry are filtered under reduced pressures. The resulting filter cake is mixed with 100 parts of ion-exchange water by a homomixer at a revolution of 8,000 rpm for 10 minutes and then filtered, thus obtaining a filter cake (i). The filter cake (i) is mixed with 100 parts of ion-exchange water by a homomixer at a revolution of 8,000 rpm for 10 minutes and then filtered under reduced pressures, thus obtaining a filter cake (ii). The filter cake (ii) is mixed with 100 parts of 10% aqueous solution of sodium hydroxide by a homomixer at a revolution of 8,000 rpm for 10 minutes and then filtered, thus obtaining a filter cake (iii). The filter cake (iii) is mixed with 100 parts of 10% hydrochloric acid by a homomixer at a revolution of 8,000 rpm for 10 minutes and then filtered, thus obtaining a filter cake (iv). The filter cake (iv) is mixed with 300 parts of ion-exchange water by a homomixer at a revolution of 8,000 rpm for 10 minutes and then filtered under reduced pressures. This operation is repeated twice, thus obtaining a filter cake (v). The filter cake (v) is dried by a circulating air dryer at 45° C. for 48 hours and then sieved with a mesh having an opening of 75 μm. Thus, a comparative toner 3 (i.e., mother toner particles obtained by an emulsion method) is prepared.

The comparative toner 3 is subjected to various measurements and evaluations in the same manner as Example 1. The results are shown in Table 3-3. FIG. 7H is a scanning electron microscope (SEM) image of the comparative toner 3.

### Comparative Example 4

The procedure in Comparative Example 3 is repeated except for changing the procedure for preparing the organic solvent phase as described below. Thus, a comparative toner 4 is prepared.

### Preparation of Organic Solvent Phase

The procedure in Comparative Example 3 is repeated except for replacing the carnauba wax with a mixture of the wax 2 and the wax 3. The comparative toner 4 is subjected to various measurements and evaluations in the same manner as Example 1. The results are shown in Table 3-3.

### Comparative Example 5

The procedure in Comparative Example 3 is repeated except for changing the procedure for preparing the organic solvent phase as described below. Thus, a comparative toner 5 is prepared.

### Preparation of Organic Solvent Phase

The procedure in Comparative Example 3 is repeated except for replacing the carnauba wax with a mixture of the wax 1 and the wax 7. The comparative toner 5 is subjected to various measurements and evaluations in the same manner as Example 1. The results are shown in Table 3-3.

### Comparative Example 6

The procedure in Comparative Example 3 is repeated except for changing the procedure for preparing the organic solvent phase as described below. Thus, a comparative toner 6 is prepared.

### Preparation of Organic Solvent Phase

The procedure in Comparative Example 3 is repeated except for replacing the carnauba wax with a mixture of the wax 2 and the wax 5. The comparative toner 6 is subjected to various measurements and evaluations in the same manner as Example 1. The results are shown in Table 3-3.

### Comparative Example 7

The procedure in Comparative Example 3 is repeated except for changing the procedure for preparing the organic solvent phase as described below. Thus, a comparative toner 7 is prepared.

### Preparation of Organic Solvent Phase

The procedure in Comparative Example 3 is repeated except for replacing the carnauba wax with a mixture of the wax 5 and the wax 6. The comparative toner 7 is subjected to various measurements and evaluations in the same manner as Example 1. The results are shown in Table 3-3.

TABLE 2-1

| | | Example No. | | | | | | |
|---|---|---|---|---|---|---|---|---|
| (parts) | | 1 | 2 | 3 | 4 | 5 | 6 | 7 |
| Polyester Resin A | | 36.7 | 62.2 | 62.2 | 67.8 | 74.8 | 68.8 | 74.3 |
| Crystalline Polyester Resin A′ | | 2.2 | 4.4 | 4.4 | 4.4 | 4.4 | 4.4 | 4.4 |
| Colorant | Colorant | 3.1 | 6.2 | 6.2 | 6.2 | 6.2 | 6.2 | 6.2 |
| Dispersion | Colorant Dispersing | 4.6 | 9.2 | 9.2 | 9.2 | 9.2 | 9.2 | 9.2 |
| Liquid | Resin | | | | | | | |
| | Ethyl Acetate | 30.8 | 61.6 | 61.6 | 61.6 | 61.6 | 61.6 | 61.6 |
| Wax | Wax 1 | 2.8 | — | — | — | — | — | — |
| | Wax 2 | — | 16.8 | — | 11.2 | — | 6 | — |
| | Wax 3 | — | — | 16.8 | — | — | 4 | 4 |
| | Wax 4 | — | — | — | — | 4.0 | — | — |
| | Wax 5 | — | — | — | — | — | — | 0.5 |
| | Wax 6 | — | — | — | — | — | — | — |
| | Wax 7 | — | — | — | — | — | — | — |
| Clay Mineral | SPN | — | — | — | — | — | — | — |
| (Synthetic | | | | | | | | |
| Smectite) | | | | | | | | |
| Charge | FCA-N | 0.7 | 1.4 | 1.4 | 1.4 | 1.4 | 1.4 | 1.4 |
| Controlling | | | | | | | | |
| Agent | | | | | | | | |

| | | | | | | | |
|---|---|---|---|---|---|---|---|
| Ethyl Acetate | 919.2 | 838.4 | 838.4 | 838.4 | 838.4 | 838.0 | 838.0 |
| Solid Content | 50 | 100 | 100 | 100 | 100 | 100 | 100 |
| Total | 1000 | 1000 | 1000 | 1000 | 1000 | 1000 | 1000 |

TABLE 2-2

| | | Example No. | | | | | |
|---|---|---|---|---|---|---|---|
| (parts) | | 8 | 9 | 10 | 11 | 12 | 13 |
| Polyester Resin A | | 69.8 | 72.3 | 72.3 | 71.8 | 74.3 | 79.0 |
| Crystalline Polyester Resin A′ | | 4.4 | 4.4 | 4.4 | 4.4 | 4.4 | 4.4 |
| Colorant | Colorant | 6.2 | 6.2 | 6.2 | 6.2 | 6.2 | 6.2 |
| Dispersion | Colorant | 9.2 | 9.2 | 9.2 | 9.2 | 9.2 | 9.2 |
| Liquid | Dispersing | | | | | | |
| | Resin | | | | | | |
| | Ethyl Acetate | 61.6 | 61.6 | 61.6 | 61.6 | 61.6 | 61.6 |
| Wax | Wax 1 | — | — | — | — | — | 3 |
| | Wax 2 | 3 | — | — | 6 | 4 | — |
| | Wax 3 | — | 6 | — | — | — | — |
| | Wax 4 | — | — | — | — | — | — |
| | Wax 5 | — | — | 0.5 | — | 0.5 | — |
| | Wax 6 | 6 | — | 6 | — | — | — |
| | Wax 7 | — | 0.5 | — | 0.5 | — | 0.5 |
| Clay Mineral | SPN | — | — | — | — | — | — |
| (Synthetic | | | | | | | |
| Smectite) | | | | | | | |
| Charge | FCA-N | 1.4 | 1.4 | 1.4 | 1.4 | 1.4 | 1.4 |
| Controlling | | | | | | | |
| Agent | | | | | | | |
| Ethyl Acetate | | 838.0 | 838.0 | 839.0 | 838.0 | 835.0 | 838.0 |
| Solid Content | | 100 | 100 | 100 | 100 | 100 | 100 |
| Total | | 1000 | 1000 | 1000 | 1000 | 1000 | 1000 |

TABLE 2-3

| | | Comparative Example No. | | | | | | |
|---|---|---|---|---|---|---|---|---|
| (parts) | | 1 | 2 | 3 | 4 | 5 | 6 | 7 |
| Polyester Resin A | | 79.0 | 56.6 | As described in the specification | | | | |
| Crystalline Polyester Resin A′ | | 4.4 | 4.4 | | | | | |
| Colorant | Colorant | 6.2 | 6.2 | | | | | |
| Dispersion | Colorant Dispersing | 9.2 | 9.2 | | | | | |
| Liquid | Resin | | | | | | | |
| | Ethyl Acetate | 61.6 | 61.6 | | | | | |
| Wax | Wax 1 | — | — | | | | | |
| | Wax 2 | — | 5.6 | | | | | |
| | Wax 3 | — | — | | | | | |
| | Wax 4 | — | — | | | | | |
| | Wax 5 | — | — | | | | | |
| | Wax 6 | — | — | | | | | |
| | Wax 7 | — | — | | | | | |
| Clay Mineral | SPN | — | 16.8 | | | | | |
| (Synthetic | | | | | | | | |
| Smectite) | | | | | | | | |
| Charge | FCA-N | 1.4 | 1.4 | | | | | |
| Controlling | | | | | | | | |
| Agent | | | | | | | | |

| | | |
|---|---|---|
| Ethyl Acetate | 838.4 | 838.4 |
| Solid Content | 100 | 100 |
| Total | 1000 | 1000 |

TABLE 3-1

| | Example No. | | | | | | |
|---|---|---|---|---|---|---|---|
| (parts) | 1 | 2 | 3 | 4 | 5 | 6 | 7 |
| Average Circularity | 0.968 | 0.961 | 0.966 | 0.975 | 0.968 | 0.972 | 0.977 |
| Mode Particle Diameter (Number based) | 5.5 | 5.2 | 5.4 | 5.3 | 5.4 | 5.2 | 5.5 |
| θmax (μm) | | | | | | | |
| Ratio of particles having a particle | 0.2 | 0.8 | 0.4 | 0.5 | 1.0 | 0.6 | 0.7 |
| diameter 0.75 × θmax or less and | | | | | | | |
| a circularity 0.980 or less (%) | | | | | | | |
| Standard Deviation of Count Number | 260 | 220 | 250 | 240 | 225 | 230 | 223 |
| Amount of Extracted Wax (mg) | 35 | 100 | 86 | 78 | 32 | 70 | 25 |
| Dv | 5.7 | 6.1 | 5.8 | 5.9 | 5.9 | 5.9 | 5.9 |
| Dn | 5.6 | 5.6 | 5.6 | 5.5 | 5.4 | 5.6 | 5.4 |
| Dv/Dn | 1.02 | 1.09 | 1.04 | 1.07 | 1.09 | 1.05 | 1.07 |
| Cleanability | AA | AA | AA | A | AA | AA | AA |
| Transferability | AA | A | A | A | A | AA | AA |
| Fixable Temperature Range | B | A | B | A | B | AA | A |
| DSC Endothermic Peak Temperature (° C.) of | 67.9 | 71.0 | 63.2 | 71.0 | 66.5 | 71.3 | 82.1 |
| Extracted Wax | | | | | | 63.6 | 63.0 |

TABLE 3-2

| | Example No. | | | | | |
|---|---|---|---|---|---|---|
| (parts) | 8 | 9 | 10 | 11 | 12 | 13 |
| Average Circularity | 0.966 | 0.978 | 0.960 | 0.980 | 0.975 | 0.969 |
| Mode Particle Diameter (Number based) | 5.6 | 5.3 | 5.2 | 5.2 | 5.3 | 5.4 |
| θmax (μm) | | | | | | |
| Ratio of particles having a particle | 0.5 | 0.3 | 0.5 | 0.9 | 0.7 | 0.7 |
| diameter 0.75 × θmax or less and | | | | | | |
| a circularity 0.980 or less (%) | | | | | | |
| Standard Deviation of Count Number | 231 | 220 | 214 | 210 | 218 | 205 |
| Amount of Extracted Wax (mg) | 54 | 29 | 55 | 45 | 28 | 22 |
| Dv | 5.9 | 5.7 | 5.9 | 5.9 | 5.9 | 6.0 |
| Dn | 5.5 | 5.5 | 5.6 | 5.5 | 5.5 | 5.5 |
| Dv/Dn | 1.07 | 1.04 | 1.05 | 1.07 | 1.07 | 1.09 |
| Cleanability | AA | AA | AA | AA | AA | AA |
| Transferability | AA | AA | A | A | A | A |
| Fixable Temperature Range | AA | A | AA | AA | A | A |
| DSC Endothermic Peak Temperature (° C.) of | 71.1 | 78.0 | 83.5 | 76.5 | 83.6 | 77.0 |
| Extracted Wax | 54.3 | 63.4 | 54.7 | 71.2 | 70.9 | 67.7 |

TABLE 3-3

| | Comparative Example No. | | | | | | |
|---|---|---|---|---|---|---|---|
| (parts) | 1 | 2 | 3 | 4 | 5 | 6 | 7 |
| Average Circularity | 0.983 | 0.972 | 0.967 | 0.963 | 0.985 | 0.963 | 0.963 |
| Mode Particle Diameter (Number based) | 5.3 | 5.3 | 5.2 | 5.2 | 5.3 | 5.4 | 5.4 |
| θmax (μm) | | | | | | | |
| Ratio of particles having a particle | 3.0 | 1.5 | 5.1 | 5.5 | 5.4 | 6.1 | 5.5 |
| diameter 0.75 × θmax or less and | | | | | | | |
| a circularity 0.980 or less (%) | | | | | | | |
| Standard Deviation of Count Number | 224 | 219 | 190 | 193 | 197 | 210 | 209 |
| Amount of Extracted Wax (mg) | 0 | 25 | 34 | 31 | 29 | 27 | 34 |
| Dv | 6.5 | 5.9 | 5.7 | 5.8 | 5.7 | 5.9 | 5.7 |
| Dn | 5.6 | 5.6 | 5.0 | 5.1 | 5.0 | 5.2 | 5.0 |
| Dv/Dn | 1.16 | 1.05 | 1.14 | 1.14 | 1.14 | 1.13 | 1.14 |
| Cleanability | C | A | A | AA | A | AA | AA |
| Transferability | C | C | C | C | C | C | C |
| Fixable Temperature Range | C | A | B | A | B | B | B |
| DSC Endothermic Peak Temperature (° C.) of | n/a | 71.1 | 70.2 | 71.7 | 77.2 | 82.3 | 84.0 |
| Extracted Wax | | | | 63.3 | 67.3 | 71.5 | 55.5 |

The waxes used in Examples and Comparative Examples are summarized in Table 4.

TABLE 4

| | | | Melting Point |
|---|---|---|---|
| | Product Name | Manufacturer | (° C.) |
| Wax 1 | HNP11 | Nippon Seiro Co., Ltd. | 68.0 |
| Wax 2 | LW13 | Sanyo Chemical | 70.0 |
| | | Industries, Ltd. | |
| Wax 3 | WAX 16 | NOF Corporation | 64.1 |
| Wax 4 | Triacontane | Tokyo Chemical | 67.1 |
| | | Industry Co., Ltd. | |
| Wax 5 | WEP-5 | NOF Corporation | 83.1 |
| Wax 6 | WAX-42 | NOF Corporation | 55.2 |
| Wax 7 | HNP9 | Nippon Seiro Co., Ltd. | 76.9 |

It is clear from the evaluation results that the Example toners have a small particle diameter and very uniform particle size distribution and circularity distribution. Very few particles having too small a particle size and a shape too close to a sphere are included in these toners. Thus, these toners provide excellent cleanability and transferability.

What is claimed is:

1. A toner, comprising:
particles, each including:
a binder resin; and
a release agent,
wherein when the toner is analyzed by a flow particle image analyzer while limiting:
1) a particle diameter analysis range to 1.985 (μm)≦equivalent circle diameter (number based)<200.0 (μm);
2) a particle shape analysis range to 0.200≦circularity≦1.000; and
3) the number of limited particles satisfying the conditions 1) and 2) to from 4,800 to 5,200,
an average circularity Rave. satisfies an inequation 0.960≦Rave.≦0.980,
a mode particle diameter θmax satisfies an inequation 4.0 (μm)≦θmax≦6.0 (μm), and
the number of particles having a particle diameter equal to or less than 0.75 times the mode particle diameter θmax and a circularity equal to or more than 0.980 is 1.0% or less of the number of the limited particles.

2. The toner according to claim 1, wherein when a release agent component is extracted from 1.0 g of the toner with n-hexane, the release agent component has two or more endothermic peaks in its endothermic curve obtained by differential scanning calorimetry.

3. The toner according to claim 2, wherein the two or more endothermic peaks are observed in a temperature range not less than 60° C. and less than 80° C.

4. The toner according to claim 1, wherein when circularity is divided into circularity ranges at an interval of 0.01, and the number of particles falling in each circularity range is counted, a standard deviation of the count number is 220 or more.

5. The toner according to claim 1, wherein the release agent is a wax.

6. The toner according to claim 1, wherein a weight W of a release agent component extracted from 1.0 g of the toner with n-hexane satisfies an inequation 30 (mg)≦W≦100 (mg).

7. The toner according to claim 1, wherein a volume average particle diameter Dv (μm) and a number average particle diameter Dn (μm) of the toner satisfy an inequation 1.00≦Dv/Dn<1.15.

8. The toner according to claim 1, wherein the toner is produced by a process comprising:
discharging a toner composition liquid in which the binder resin and the release agent are dissolved or dispersed, thereby forming liquid droplets; and
solidifying the liquid droplets.

9. A developer, comprising:
the toner according to claim 1; and
a carrier.
